(19) United States
(12) Patent Application Publication
(10) Pub. No.: US 2007/0168405 A1
(43) Pub. Date: Jul. 19, 2007

(54) Self-optimizing network attached storage for multiple geographic locations

(76) Inventor: Ori Pomerantz, Austin, TX (US)

Correspondence Address: IBM CORPORATION (RHF), C/O ROBERT H. FRANTZ, P. O. BOX 23324, OKLAHOMA CITY, OK, 73123, US

(21) Appl. No.: 11/333,518

(22) Filed: Jan. 17, 2006

(51) Int. Cl. G06F 17/30; G06F 12/00

(52) U.S. Cl. 707/205; 707/204

(57) ABSTRACT

A plurality of geographically diffuse network attached file servers are configured store a file migration control table, each table to including an entry designating a root device and at least one time-decaying access control parameter for a file stored locally to each server. Upon receipt by a first server of a request from a second, geographically remote server for access to an authoritative copy of a file stored by the first server, the said first server updates a time-decaying access control parameter to reflect remote server's request, and computes an access ratio comparing requests from remote users to recent requests from local. If the ratio exceeds a threshold indicating more often or more common usage of the files by remote users than local users, the authoritative file copy is migrated automatically from the first server to the second, remote server.

### BACKGROUND OF THE INVENTION

1. Field of the Invention

This invention relates to management of file locations in a distributed data storage system having multiple geographically diffuse file servers.

2. Background of the Invention

When a company has offices in multiple locations, it is preferable to store information at the location where it is accessed most often. For example, it makes sense to store the electronic document file for a French translation of a User's Guide in France, and the Japanese translation in Japan. This type of organization of files recognizes that the files may be occasionally accessed by personnel in other geographic locations, but will be most often accessed by those in the location where the file is stored. So, by locating the file in a file server regionally close to the majority of expected users, delays to access the file by most users are minimized, placing the greatest delays and bandwidth consumption burden on remote, geographically distant users.

For example, consider the diagram of FIG. 3, wherein a distributed file system arrangement (30) including a network (35), which interconnects file servers in three geographically diffuse locations, such as Bangalore, India (31), Austin, Tex. (34), and Rome, Italy (33). Each server (310, 330, 340) has a local file system and data storage (311, 331, 341), as well as a connection to a local area network (“LAN”) (312, 332, 342), which allows a number of user's to use their workstations (313, 333, 343), such as personal computers (“PC”), personal digital assistants (“PDA”), smart phones, and other devices, to access files and data stored locally, as well as remotely via the network (35).

Now, consider an original or “authoritative” file, initially stored (399) at the Banaglore server (310), perhaps because it was originally created by staff (313) in Bangalore, or was initially needed most often during product pre-release activities by Bangalore staff (313). During this initial period, most accesses to the file will be local, involving traffic only over the Bangalore LAN (312). Some accesses from remote users (343, 333) are still possible, but they will incur delays and will consume network bandwidth due to involvement of the corresponding LANs (332, 342), and the intervening network (35), such as the Internet or a Virtual Private Network (“VPN”).

Now, consider a subsequent period of time, such as a product post-release period, when perhaps the product is primarily deployed in the Italian market, and supported by the Italian staff (333). During this period, the authoritative file may be moved from the Bangalor server (310), to be stored locally (399″) by the Rome server (330). During this period, the increased number of accesses to the file by the Italian staff experiences minimized delays, but accesses by the Austin staff (343) or by the Bangalore staff (313) incur considerable delays.

At present, this type of geographic location optimization is typically achieved either manually, or by means of a caching proxy which stores an extra copy. Manual methods are labor intensive, and often do not lead to relocation of a file until after significant inconvenience by remote users has been incurred.

A caching proxy can more quickly respond to local needs for a remotely stored file by making a local copy of the file after several accesses have been detected. However, caching proxies by definition only create “read only”, or unmodifiable, copies of this file. For example, as shown in FIG. 3, if the authoritative copy of a file is in Bangalore (399), a caching proxy will automatically store a copy of the file in the Austin server (399′), after one or more remote accesses of the file have been made by Austin staff (343).

This is an unusable solution for remote users who need to edit or change the file, such as a document file or a database file. Further, using a caching proxy server leads to higher storage requirements (e.g. storing multiple copies of the same file), as well as increase network bandwidth consumption when the cache is originally loaded and when it is refreshed. Caching proxies can also suffer from out-of-date or “stale” data, so database applications which include time-variant information may not be suitable for use with cached copies of the database files.

A number of caching and network management technologies are known in the art, but none provide an automated, intelligent mechanism to automatically migrate an authoritative copy of a file from one server to another in such a geographically distributed file system. For example, systems such as those described in U.S. Pat. Nos. 6,823,377; and 6,754,699; and US published patent applications 2002/0083187; 2002/0055972; and 2004/0221019 deal with caching of files, rather than moving the authoritative copy, so they only provide read-only access to remote users. Other technologies, such as that described in published US patent application 2002/0138744, provides with peer-to-peer file distribution which also allows read-only access to remote users, but does not allow file modification. Still other technologies integrate functions, such as that shown in published US patent applications 2002/0065938 and 2002/0009079, which provide methods for building a firewall and/or cache.

For these reasons, there is a need in the art for a system and method to automatically relocate or migrate authoritative files from one server to another, wherein the servers are geographically diffuse, and wherein modify operations of the authoritative copy must be allowed by remote users and programs, with minimized delays and network resource consumption, by automatically locating each authoritative copy in a file server local to the most recent and most common users or accessers.

### SUMMARY OF THE INVENTION

The present invention provides a system and method to automatically relocate or migrate authoritative files from one server to another, wherein the servers are geographically diffuse, and wherein modify operations of the authoritative copy must be allowed by remote users and programs, with minimized delays and network resource consumption, by automatically locating each authoritative copy in a file server local to the most recent and most common users or accessers. The system employs distributed management controls among the geographically diffuse file servers which maintain knowledge of the current location of each authoritative file, determine when a set of remote users become the most common users of each authoritative file using time-decaying analysis functions, and automatically migrate each authoritative file to be locally stored in the same geographic region, or the closest available region, as the most common users. The distributed controls automatically update throughout the system to record such file movement when it is performed.

In this manner, files which are used most often by users in a certain geographic region are automatically co-located with those frequent users, so as to minimize access delays, as well as minimize storage and network resource consumption.

### BRIEF DESCRIPTION OF THE DRAWINGS

The following detailed description when taken in conjunction with the figures presented herein provide a complete disclosure of the invention.

FIG. 1 illustrates a system view of the present invention.

FIGS. 2a and 2b show a generalized computing platform architecture, and a generalized organization of software and firmware of such a computing platform architecture.

FIG. 3 provides an depiction of a distributed file system having servers and users in geographical diffuse regions.

FIG. 4 sets forth a logical process for configuring one or more NAS servers to operate according to the present invention.

FIG. 5 sets forth a logical process for automatically migrating files according to the present invention.

### DESCRIPTION OF THE INVENTION

The present invention is preferably realized as a software function cooperative with a Network Attached Storage (“NAS”) server. It will be recognized by those skilled in the art that alternate embodiments are available within the scope of the invention, such as partial or full realization in circuitry, or as an on-demand file management service.

### General Architecture of the Invention

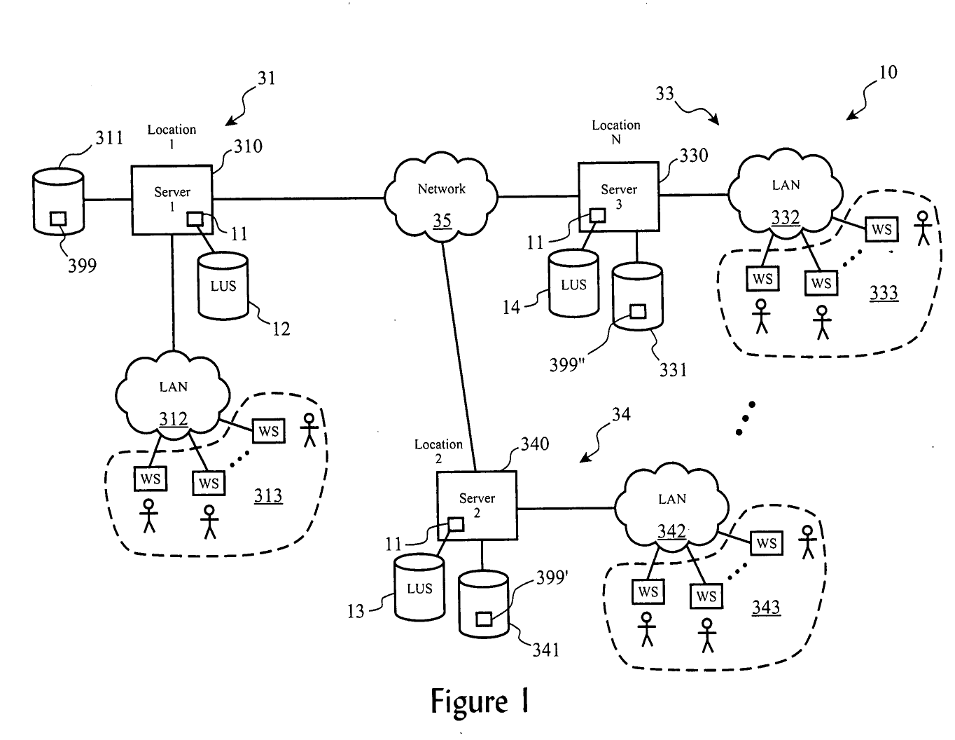

Turning to FIG. 1, a generalized system view of a distributed storage environment is shown (10) in which each NAS server (310, 340, 330) is modified to include a file migration controller module (11), and a local usage statistics (“LUS”) record (12, 13, 14), accessible by the local file migration controller module. The NAS servers and file migration controller modules may communicate among themselves using a custom Application Programming Interface (“API”), and/or using standardized or “open” interfaces, protocols, and architectures, such as, but not limited to Sun Microsystem's Network File System (“NFS”), WebNFS, Transmission Control Protocol/Internet Protocol (TCP/IP), Remote Procedure Call (“RPC”), User Datagram Protocol (“UDP”), and remote directory services and protocols such as Lightweight Directory Access Protocol (“LDAP”).

Configuration of NAS Servers

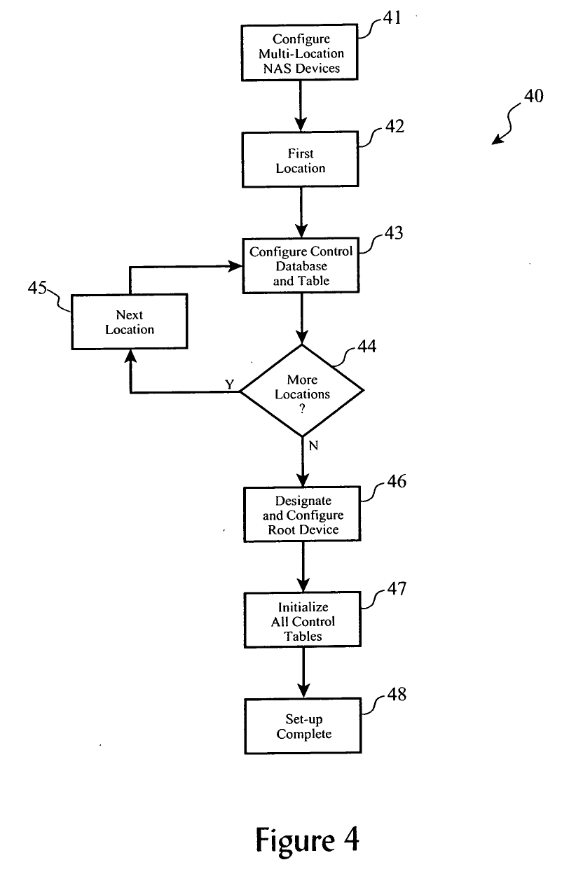

As shown (40) in FIG. 4, each NAS server in the multiple geographic location distributed file system is preferably configured (41) as a typical NAS server for its local users, and then each server for each location (42, 44, 45), a migration control database and table are configured, such as the Local Usage Statistics (12, 13, 14) of FIG. 1. Then, one server is designated (46) as a root device, and all migration control tables are initialized (48) throughout all regions, which completes the configuration of the invention prior to its operation. Table 1 provides example pseudo-code for a logical process according to this aspect of the invention.

TABLE 1
Example Initialization Process

| | |
|---|---|
| 1a. | Configure multiple NAS devices in multiple locations. |
| 1b. | Configure a database on each of the NAS devices. |
| 1c. | On each of those databases, create a table with the |
| | following columns: |

| | |
|---|---|
| i. | Filename (string) |
| ii. | Location (identifier of one of the NAS devices, can be a |
| | pointer to a different table with the NAS device's name |
| | and network identifier, or it could be the network identifier |
| | for the NAS device, such as hostname or IP address). |
| iii. | Decaying Average (real number) |
| iv. | Decaying Average From (date & time field) |

| | |
|---|---|
| 1d. | Create a root directory on one of the devices. We'll call it the |
| | root device. |
| 1e. | On all the NAS devices, insert a row with the following |
| | values in the database table: |

| Column | Initialized Value | Explanation |
|---|---|---|
| Filename | / | The root directory |
| Location | <root device> | a pointer to the root device |
| Decaying Average (DA) | 0 | “zero” to represent no |
| | | access has occurred yet |
| Decaying Avg Date | Present time | |
| (DAD) | | |

The database at the location of a directory contains links to all the files in that directory. After initialization, this property is only true in an empty way (e.g. there are no files in the root directory). However, all of the file system operations of the invention will preserve this property, so it stays true. After a process such as this is complete, the file system is now ready for use.

Control Parameters for Migration Controller Modules

Each migration controller module monitors the usage of locally stored files. Using return addresses of the file access requests, a controller module counts each access request for each file, and time stamps and categorizes it according to location from which the request comes (e.g. which region is requesting each file, and how often).

The invention preferably uses a time-decaying average to track which locations are using or accessing each file the most often. Decay functions are well known as analytical methods, and a number of varieties of them are suitable as alternatives to a typical time-decaying average, including but not limited to time-decaying summation, exponential decay, sliding windows, and polynomial decay.

More generally speaking, a decay function is a non-increasing function g(x)≧0, and where ƒ(t) is the value of an item at time t, wherein a weight at time T of an item sampled or detected at time t is g(T−t), such that the decayed value of that item is ƒ(t)·g(T−t). A time-decayed average, then, can be generally expressed as the average of a number of decayed values.

According to one aspect of the present invention, a time-decaying average is used to monitor the accesses of each file by users in each region, such that all users served by a remote server are summed and averaged together. As such, according to one embodiment, the control parameters are initialized for each migration controller module as shown in Table 2.

TABLE 2
Example Time-Decay Control Parameters

| Parameter | Explanation |
|---|---|
| T | a constant, preferably slightly below the value of |
| | one (e.g. 0.9999). This constant determines how fast the |
| | decaying average decays |
| DAₘᵢₙ | a minimum value for the decaying average, after which |
| | a file would be transferred to another location. If the |
| | location's decaying average isn't at least Dₘᵢₙ, the |
| | file remains stored at its currently location in order to |
| | avoid having a rarely used file being migrated or moved |
| | every time it is accessed. |
| DAᵣₐₜᵢₒ | a minimum value of DA_{at future location}/DA_{at current location} for a |
| | file to be automatically relocated to another region. |

Operational Methods for File Migration

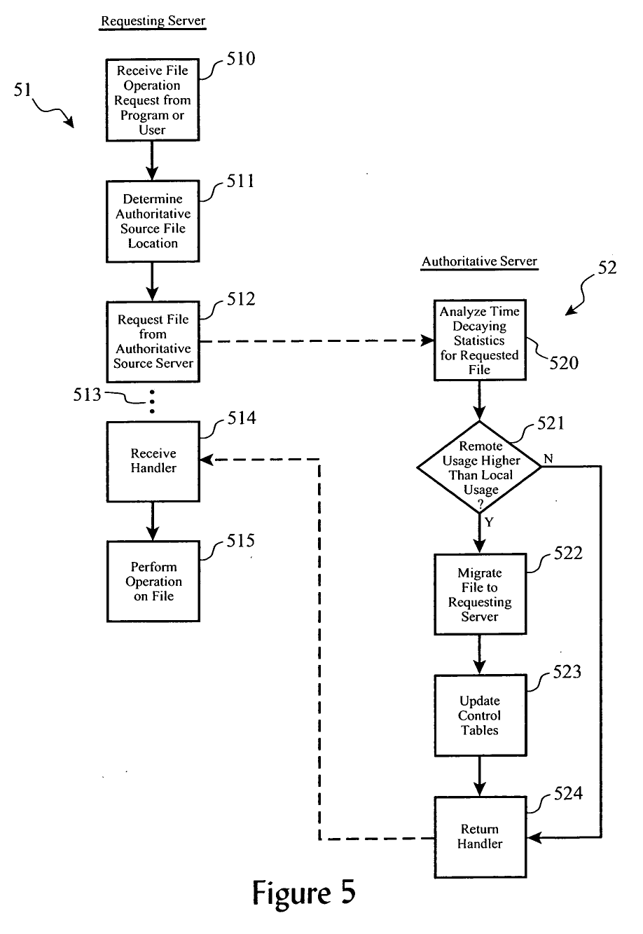

Turning to FIG. 5, a logical process for a requesting server or user (51) and a server where the authoritative copy is stored (52) is shown in a general manner. Although the example shown can represent processes being performed cooperatively on two separate servers remotely located from each other, they may also be performed by the same server, such as the case when a local user requests access to a locally stored file.

The requesting server receives a file operation request on a particular file, usually identified by a file name, from a local user or program (510). The requesting server then determines which NAS server holds the authoritative copy (511) by examining its local migration control table. Following this identification, a request to perform a file operation, such as read, modify, delete, etc., is sent to the identified authoritative server (512).

The authoritative server then updates and analyzes the time decaying statistics for the file to which access is being requested (520). If certain thresholds are met or exceeded which indicate the users at the remote (requesting) server have been accessing this file more often and more recently than the users local to the authoritative server (521). If so, then the authoritative copy of the file is migrated to the requesting server from the authoritative server (522), and all of the migration control tables are updated for all of the migration control modules throughout the distributed file system. This renders the requesting server as the authoritative server, as the file is now co-located with the users who have most recently and most often accessed the file.

If the remote usage does not exceed certain thresholds compared to usage by the users local to the authoritative server (521), then a handler to the file is simply returned to the requesting server (514), such that the requested file operation can be performed remotely. In this case, the file does not migrate, but instead remains at the location of the current authoritative server.

Many variations of implementation of these general steps are available to realize the invention. Tables 3, 4, 5, 6 and 7 illustrate using pseudo-code some implementations of some ordinary file operations.

TABLE 3
Example “Find File” Operation

// This algorithm finds the NAS device that is the authoritative source for
// that file. A file can also be a directory.

| | |
|---|---|
| 3a. | If the file is in the database of the current device, get the |
| | location from that database row. |
| 3b. | If the file is not in the database for the current NAS device, then: |

| | |
|---|---|
| i. | Find the nearest ancestor of the directory that is in the |
| | database // In the worst case, the root directory will be at the |
| | // database table, with the location of the root device. |
| ii. | Set curr_loc to the location of the nearest known ancestor and |
| | curr_path to the value of the nearest known ancestor. |
| iii. | Until curr_path is equal to the directory to be listed, find the |
| | next path component (for example, in the path |
| | /var/spool/mail/root, if curr_path is /var/spool, then the next |
| | component is mail and the full path with it would be |
| | /var/spool/mail) in that directory in the table on curr_loc |
| | // Since curr_loc is the location of curr_path, it is guaranteed |
| | to have that. |
| | (1) Set curr_path to curr_path + the next component. |
| | (2) Set curr_loc to the location of the new curr_path, |
| | which is available in the database table for the current |
| | value of curr_loc |
| iv. | Once curr_path is the directory to be listed, the curr_loc is |
| | the correct location. |

In order to fully implement the advantages of the current invention, a file system must support, at the minimum, the following operations:
(a) list the files in a directory;
(b) open a file;
(c) read/write/seek/close a file;
(d) create a new file or directory; and
(e) delete a file.

Other operations, such as changing the current directory, can be simulated locally. The following algorithms implement these operations on any of the NAS devices, keeping location information transparent to the end user. In all of the following implementations, Local is the current NAS device, the one to which a requesting user is connected (e.g. in the same region as a requesting user or program).

TABLE 4
Example “List Directory Contents” Operation

| | |
|---|---|
| 4a. | Use the invention's Find File Location method to find the directory's |
| | location F_Loc. |
| 4b. | From the directory located at F_Loc, get all of the files and |
| | directories under the directory. // This has to be done from the |
| | // database table, not the remote server itself |
| 4c. | Report the files and directories to the user or program that asked for |
| | the listing. |

TABLE 5
Example “Open File” Operation

| | |
|---|---|
| 5a. | Use the invention's Find File Location method to find the file's |
| | location F_Loc |
| 5b. | At F_Loc, update the following on the database row for the file: |
| | i. DA <- DA*T\hat{ }(now-DAD). // This means the decaying average |
| | // is multiplied by T for every second that passed since it was last |
| | // calculated. |
| | ii. DAD <- now |
| 5c. | At Local, if there is no database row for the file, create it with |
| | DA = 1, DAD = now, else, if there is one, update the following: |
| | i. DA <- DA*T\hat{ }(now-DAD) + 1. // This means the decaying |
| | // average is multiplied by T for every second that passed since |
| | // it was last calculated. Then one is added for the current access. |
| | ii. DAD <- now |
| 5d. | If Local.DA > DAₘᵢₙ and Local.DA/F_Loc.DA > DA_{Ratio}, then |
| | migrate the file to Local by: |
| | i. Copy the file from F_Loc to Local, creating any directories |
| | necessary to support this on Local. // For example, when migrating |
| | // /var/spool/mail/root, it might be necessary to create /, /var, |
| | // /var/spool, and /var/spool/mail. |
| | ii. Broadcast a message to all NAS in the system that this file now |
| | resides at Local. The receiving NAS system can either update the |
| | appropriate row (if it has one for this file), or ignore the message. |
| | iii. Delete the file from F_Loc |
| | iv. Set F_Loc to Local |
| 5e. | Open the file with the appropriate mode in F_Loc, which may or |
| | may not be Local. Return a handler or a failure, as per the standard |
| | open( ) system call. |

TABLE 6
Example “Read/Write/Seek/Close” Operation

| | |
|---|---|
| 6a. | Use the invention's Find File Location method to find the file's |
| | location F_Loc |
| 6b. | If Local is not the same as the file's location, simulate the file |
| | being at Local by having Local act as a proxy for the requests |
| | between the user and F_Loc. // This can be done by |
| | // custom code, or using a mechanism such as Networked File |
| | System (NFS) or Microsoft File Sharing. |

TABLE 7
Example “Create File” Operation

| 7a. | Use the invention's Find File Location method to find the location for | |
|---|---|---|
| | the directory in which the file is to be created D_Loc. | |
| | // For example, if the file is /var/spool/mail/root, then D_Loc is the | |
| | // location of/var/spool/mail. | |
| 7b. | Verify that a file by this name is not known to D_Loc. If it is, then | |
| | fail with an error that specifies that the file already exists. | |
| 7c. | Create the following table rows in the migration control table in both | |
| | D_Loc and Local: | |
| | i. | Filename containing the filename to create |
| | ii. | Location is Local |
| | iii. | DA = 0 // e.g. set DA to zero |
| | iv. | DAD = now // e.g. set DAD to the current time |

| | |
|---|---|
| 7d. | Create the actual file, as well as any directories leading to it, on |

// Local. For example, if Local has just /var, create /var/spool,

// /var/spool/mail, and /var/spool/mail/root to create the
// /var/spool/mail/root file.

TABLE 8
Example “Delete File” Operation

| | |
|---|---|
| 8a. | Use the inventions Find File Location method to find the file's |
| | location F_Loc |
| 8b. | Delete the file at F_Loc |
| 8c. | Broadcast a message to all the migration control modules in the NAS |
| | devices participating in the file system that the file has been deleted, |
| | upon receipt of which each migration control module deletes the |
| | corresponding row or entry in the local migration control table. |

### ADVANCED OPTIONAL EMBODIMENTS

The foregoing realizations of the invention may be enhanced or advanced to including or cooperate with caching of files. Another advanced embodiment can use the amount of data transferred, rather than just how many times the file was open, in the decaying average decision logic to determine is a file is to be transferred to a new NAS device.

Suitable Computing Platform

The invention is preferably realized as a feature or addition to the software already found present on well-known computing platforms such as personal computers, web servers, and web browsers. These common computing platforms can include personal computers as well as portable computing platforms, such as personal digital assistants (“PDA”), web-enabled wireless telephones, and other types of personal information management (“PIM”) devices.

Therefore, it is useful to review a generalized architecture of a computing platform which may span the range of implementation, from a high-end web or enterprise server platform, to a personal computer, to a portable PDA or web-enabled wireless phone.

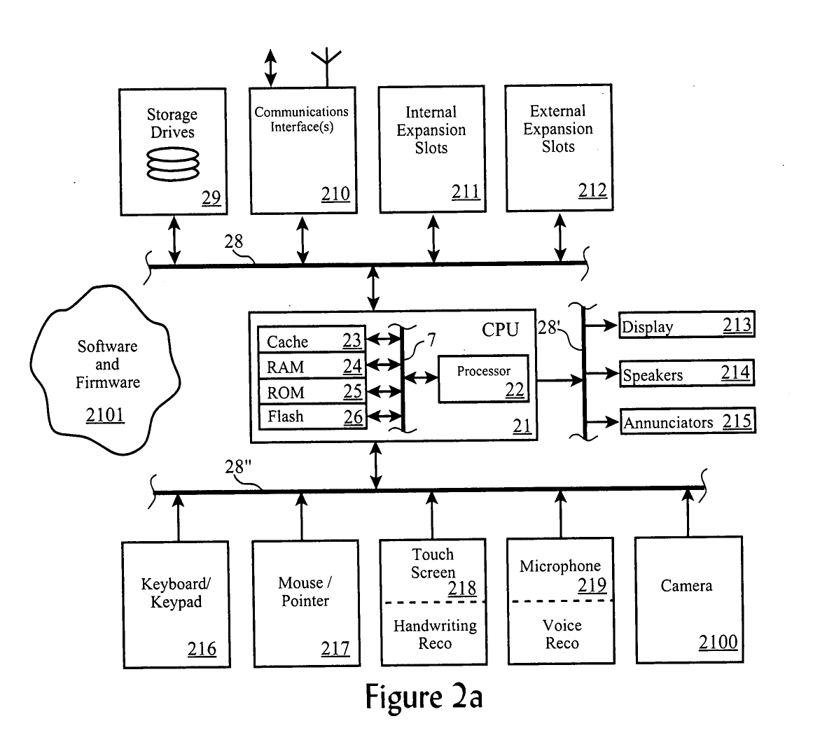

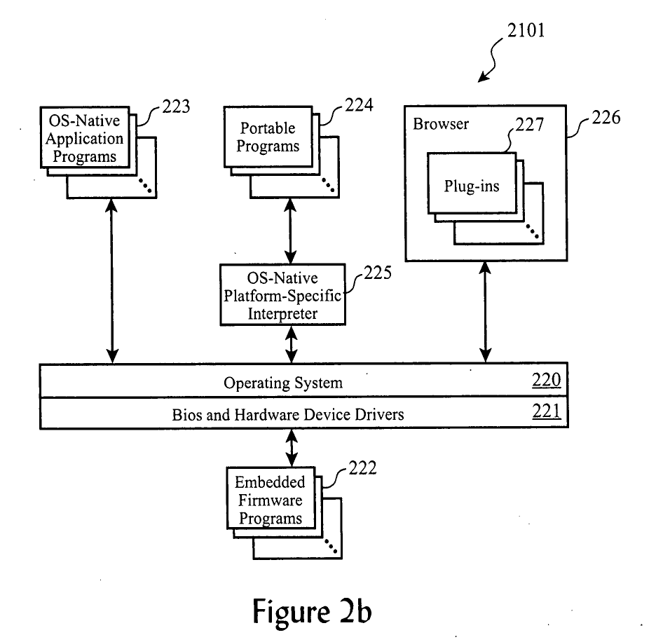

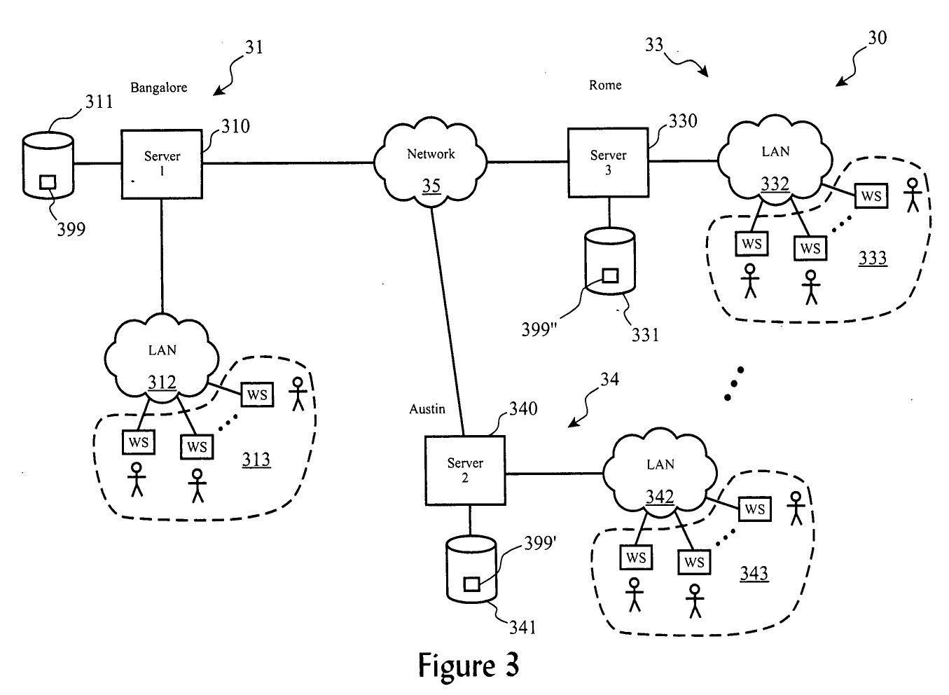

Turning to FIG. 2a, a generalized architecture is presented including a central processing unit (21) (“CPU”), which is typically comprised of a microprocessor (22) associated with random access memory (“RAM”) (24) and read-only memory (“ROM”) (25). Often, the CPU (21) is also provided with cache memory (23) and programmable FlashROM (26). The interface (27) between the microprocessor (22) and the various types of CPU memory is often referred to as a “local bus”, but also may be a more generic or industry standard bus.

Many computing platforms are also provided with one or more storage drives (29), such as a hard-disk drives (“HDD”), floppy disk drives, compact disc drives (CD, CD-R, CD-RW, DVD, DVD-R, etc.), and proprietary disk and tape drives (e.g., lomega Zip™ and Jaz™, Addonics SuperDisk™, etc.). Additionally, some storage drives may be accessible over a computer network.

Many computing platforms are provided with one or more communication interfaces (210), according to the function intended of the computing platform. For example, a personal computer is often provided with a high speed serial port (RS-232, RS-422, etc.), an enhanced parallel port (“EPP”), and one or more universal serial bus (“USB”) ports. The computing platform may also be provided with a local area network (“LAN”) interface, such as an Ethernet card, and other high-speed interfaces such as the High Performance Serial Bus IEEE-1394.

Computing platforms such as wireless telephones and wireless networked PDA's may also be provided with a radio frequency (“RF”) interface with antenna, as well. In some cases, the computing platform may be provided with an infrared data arrangement (“IrDA”) interface, too.

Computing platforms are often equipped with one or more internal expansion slots (211), such as Industry Standard Architecture (“ISA”), Enhanced Industry Standard Architecture (“EISA”), Peripheral Component Interconnect (“PCI”), or proprietary interface slots for the addition of other hardware, such as sound cards, memory boards, and graphics accelerators.

Additionally, many units, such as laptop computers and PDA's, are provided with one or more external expansion slots (212) allowing the user the ability to easily install and remove hardware expansion devices, such as PCMCIA cards, SmartMedia cards, and various proprietary modules such as removable hard drives, CD drives, and floppy drives.

Often, the storage drives (29), communication interfaces (210), internal expansion slots (211) and external expansion slots (212) are interconnected with the CPU (21) via a standard or industry open bus architecture (28), such as ISA, EISA, or PCI. In many cases, the bus (28) may be of a proprietary design.

A computing platform is usually provided with one or more user input devices, such as a keyboard or a keypad (216), and mouse or pointer device (217), and/or a touch-screen display (218). In the case of a personal computer, a full size keyboard is often provided along with a mouse or pointer device, such as a track ball or TrackPoint™. In the case of a web-enabled wireless telephone, a simple keypad may be provided with one or more function-specific keys. In the case of a PDA, a touch-screen (218) is usually provided, often with handwriting recognition capabilities.

Additionally, a microphone (219), such as the microphone of a web-enabled wireless telephone or the microphone of a personal computer, is supplied with the computing platform. This microphone may be used for simply reporting audio and voice signals, and it may also be used for entering user choices, such as voice navigation of web sites or auto-dialing telephone numbers, using voice recognition capabilities.

Many computing platforms are also equipped with a camera device (2100), such as a still digital camera or full motion video digital camera.

One or more user output devices, such as a display (213), are also provided with most computing platforms. The display (213) may take many forms, including a Cathode Ray Tube (“CRT”), a Thin Flat Transistor (“TFT”) array, or a simple set of light emitting diodes (“LED”) or liquid crystal display (“LCD”) indicators.

One or more speakers (214) and/or annunciators (215) are often associated with computing platforms, too. The speakers (214) may be used to reproduce audio and music, such as the speaker of a wireless telephone or the speakers of a personal computer. Annunciators (215) may take the form of simple beep emitters or buzzers, commonly found on certain devices such as PDAs and PIMs.

These user input and output devices may be directly interconnected (28′, 28″) to the CPU (21) via a proprietary bus structure and/or interfaces, or they may be interconnected through one or more industry open buses such as ISA, EISA, PCI, etc.

The computing platform is also provided with one or more software and firmware (2101) programs to implement the desired functionality of the computing platforms.

Turning to now FIG. 2b, more detail is given of a generalized organization of software and firmware (2101) on this range of computing platforms. One or more operating system (“OS”) native application programs (223) may be provided on the computing platform, such as word processors, spreadsheets, contact management utilities, address book, calendar, email client, presentation, financial and bookkeeping programs.

Additionally, one or more “portable” or device-independent programs (224) may be provided, which must be interpreted by an OS-native platform-specific interpreter (225), such as Java™ scripts and programs.

Often, computing platforms are also provided with a form of web browser or micro-browser (226), which may also include one or more extensions to the browser such as browser plug-ins (227).

The computing device is often provided with an operating system (220), such as Microsoft Windows™, UNIX, IBM OS/2™, IBM AIX™, open source LINUX, Apple's MAC OS™, or other platform specific operating systems. Smaller devices such as PDA's and wireless telephones may be equipped with other forms of operating systems such as real-time operating systems (“RTOS”) or Palm Computing's PalmOS™.

A set of basic input and output functions (“BIOS”) and hardware device drivers (221) are often provided to allow the operating system (220) and programs to interface to and control the specific hardware functions provided with the computing platform.

Additionally, one or more embedded firmware programs (222) are commonly provided with many computing platforms, which are executed by onboard or “embedded” microprocessors as part of the peripheral device, such as a micro controller or a hard drive, a communication processor, network interface card, or sound or graphics card.

As such, FIGS. 2a and 2b describe in a general sense the various hardware components, software and firmware programs of a wide variety of computing platforms, including but not limited to personal computers, PDAs, PIMs, web-enabled telephones, and other appliances such as WebTV™ units. As such, we now turn our attention to disclosure of the present invention relative to the processes and methods preferably implemented as software and firmware on such a computing platform. It will be readily recognized by those skilled in the art that the following methods and processes may be alternatively realized as hardware functions, in part or in whole, without departing from the spirit and scope of the invention.

The methods and processes of the invention and it's associated components may be realized as a standalone executable script, Java Bean, application program, plug-in, etc., which accesses and modifies certain system files and resources as described in more detail in the following paragraphs, but may well be integrated into existing software such as NAS server software programs, without departing from the spirit and scope of the invention. Further, it will be recognized by those skilled in the are that the foregoing detailed examples of implementations of the invention are illustrative in nature, and that many variations within the spirit and scope of the invention are available, including but not limited to employ of alternate programming languages, methodologies, as well as use of alternate computing platforms and alternate communications and networking protocols. For these reasons, the scope of the present invention should be determined by the following claims.

What is claimed is:

1. A method comprising the steps of:
configuring a plurality of geographically diffuse network attached file servers to operate a file migration controller and to store a file migration control table;
configuring said file migration control tables to include an entry designating a root device, and at least one time-decaying access control parameter for a file stored locally to one of said servers;
receiving by a first server a request from a second, geographically remote server for access to an authoritative copy of a file stored by said first server;
updating said time-decaying access control parameter to reflect said remote server's request;
computing by a server a relative access measurement comparing requests from said remote server to requests received from users of said first server; and
responsive to determination that said relative access measurement exceeds a threshold, migrating said authoritative file copy to be stored by said second server.

2. The method as set forth in claim 1 wherein said step of migrating comprises broadcasting a message from said first server to said plurality of servers, and whereupon receipt of said message, said plurality of servers modify said migration control tables to reflect a new location of said authoritative file copy.

3. The method as set forth in claim 1 wherein said step of updating said time-decaying access control parameter comprises updating a time-decaying average value.

4. The method as set forth in claim 1 wherein said step of updating said time-decaying access control parameter comprises updating a value according to a method selected from the group of a time-decaying summation, an exponential decay method, a sliding window method, and a polynomial decay method.

5. The method as set forth in claim 1 wherein said step of configuring a plurality of geographically diffuse network attached file servers further comprises configuring one or more caching proxy servers to handle non-authoritative copies of files.

6. The method as set forth in claim 1 wherein said step of updating by said first server said time-decaying access control parameter further comprises updating said control parameter according to an amount of data transfer associated with said file operation request.

7. A system comprising:
a plurality of file migration control tables, each of which is configured to be accessible by one of a plurality of geographically diffuse network attached file servers, said tables to including an entry designating a root device and at least one time-decaying access control parameter for a file stored locally to one of said servers;
a request received by a first server from a second, geographically remote server for access to an authoritative copy of a file stored by said first server;
a first migration controller configured to be operable by said first server, adapted to update said time-decaying access control parameter to reflect said remote server's request, compute a relative access measurement comparing requests from said remote server to requests received from users of said first server, and to, responsive to determination that said relative access measurement exceeds a threshold, initiate migration said authoritative file copy to be stored by said second server; and
a second migration controller configured to be operable by said second, remote requesting server, adapted to receive and store said authoritative file, thereby completing said migration.

8. The system as set forth in claim 7 further comprising a broadcast message from said first server to said plurality of servers, and whereupon receipt of said message, said plurality of servers modify said migration control tables to reflect a new location of said authoritative file copy.

9. The system as set forth in claim 7 wherein said time-decaying access control parameter comprises a time-decaying average value.

10. The system as set forth in claim 7 wherein said time-decaying access control parameter comprises a value selected from the group of a time-decaying sum, an exponential decay parameter, a sliding window parameter, and a polynomial decay parameter.

11. The system as set forth in claim 7 further comprising one or more caching proxy servers configured to cooperatively handle non-authoritative copies of files.

12. The system as set forth in claim 7 wherein said first migration controller is further adapted to update said control parameter according to an amount of data transfer associated with said file operation request.

13. A device comprising:
a computer-readable medium; and
one or more software program products encoded in or on said computer-readable medium and adapted to cause a plurality of geographically diffuse network attached servers to perform the steps of:
(a) store a file migration control table which include an entry designating a root device, and at least one time-decaying access control parameter for a file stored locally to one of said servers;
(b) receive by a first server a request from a second, geographically remote server for access to an authoritative copy of a file stored by said first server;
(c) update by said first server said time-decaying access control parameter to reflect said remote server's request;
(d) compute by a server a relative access measurement comparing requests from said remote server to requests received from users of said first server; and
(e) responsive to determination that said relative access measurement exceeds a threshold, migrate said authoritative file copy to be stored by said second server.

14. The device as set forth in claim 13 wherein said step of migrating comprises broadcasting a message from said first server to said plurality of servers, and whereupon receipt of said message, said plurality of servers modify said migration control tables to reflect a new location of said authoritative file copy.

15. The device as set forth in claim 13 wherein said step of updating said time-decaying access control parameter comprises updating a time-decaying average value.

16. The device as set forth in claim 13 wherein said step of updating said time-decaying access control parameter comprises updating a value according to a method selected from the group of a time-decaying summation, an exponential decay method, a sliding window method, and a polynomial decay method.

17. The device as set forth in claim 13 wherein said step of configuring a plurality of geographically diffuse network attached file servers further comprises configuring one or more caching proxy servers to handle non-authoritative copies of files.

18. The device as set forth in claim 13 wherein said step of updating by said first server said time-decaying access control parameter further comprises updating said control parameter according to an amount of data transfer associated with said file operation request.

19. The device as set forth in claim 13 wherein said computer-readable medium comprises one or more mediums selected from the group of computer memory, a computer disk, a computer tape, a modulated electronic signal carried on a wire, and a modulated electronic signal transmitted wirelessly.
